(19) United States
(12) Patent Application Publication
(10) Pub. No.: US 2007/0168373 A1
(43) Pub. Date: Jul. 19, 2007

(54) GUI component feedback for functional tasks that are qualified by performance or quality

(75) Inventors: Richard D. Dettinger, Rochester, MN (US); Frederick A. Kulack, Rochester, MN (US); Kevin G. Paterson, San Antonio, TX (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/335,783

(22) Filed: Jan. 19, 2006

(51) Int. Cl. G06F 7/00

(52) U.S. Cl. 707/101

(57) ABSTRACT

Embodiments of the invention allow a user to obtain information regarding the possible effects of invoking a user-selectable component provided by a software application, such as a user selected menu function or a database query element that may be added to a database query. Generally, a user selected component is analyzed to determine the expected execution characteristic of the component, and an expected execution characteristic may be associated with a graphical display component used to access the user-selectable component.

### BACKGROUND OF THE INVENTION

1. Field of the Invention

The present invention is generally directed to providing feedback to users of software applications. More specifically, the present invention is directed to presenting users with expected performance characteristics regarding various aspects of software application performance.

2. Description of the Related Art

Databases are computerized information storage and retrieval systems. A relational database management system (RDBMS) is a computer database management system that uses relational techniques for storing and retrieving data. Relational databases are computerized information storage and retrieval systems in which data in the form of tables (formally denominated “relations”) are typically stored for use on disk drives or similar mass data stores. A “table” includes a set of rows (formally denominated “tuples” or “records”) spanning several columns (formally denominated “attributes”). Reference is made to C. J. Date, An Introduction to Database Systems, 6th edition, Addison-Wesley Publishing Co. Reading, Mass. (1994) for a comprehensive general treatment of the relational database art.

An RDBMS is structured to accept commands to store, retrieve and delete data using, for example, high-level query languages such as the Structured Query Language (SQL). The term “query” denominates a set of commands for retrieving data from a stored database. These queries may come from users, application programs, or remote systems (clients or peers). The query language requires the return of a particular data set in response to a particular query but the method of query execution (“Query Execution Plan”) employed by the RDBMS is not specified by the query. The method of query execution is typically called an execution plan, an access plan, or just “plan”. There are typically many different useful execution plans for any particular query, each of which returns the required data set. A typical RDBMS maintains statistics gathered by the RDBMS for data present in tables and columns. During construction of a query execution plan, query optimization components in the RDBMS use the statistics as well as the syntax of the query itself to analyze the costs of alternative query plans. The query optimization component provides a way for an application or RDBMS to generate a cost estimate for a query or for a part of a query. For large databases, the execution plan selected by the RDBMS to execute a query must provide the required data at a reasonable cost in time and hardware resources. For sufficiently complex databases even the most efficient query plan can still take exceedingly long times to execute.

A query may specify which columns to retrieve data from, how to join columns from multiple tables, and conditions that must be satisfied for a particular data record to be included in a query result set. Current relational databases typically process queries composed in an exacting format specified by a query language. For example, the widely used query language SQL (short for Structured Query Language) is supported by virtually every database available today. An SQL query is composed from one or more clauses set off using specific keywords. However, composing a proper SQL query requires that a user understand the structure and content of the relational database (i.e., a schema of tables and columns) as well as the complex syntax of the SQL query language. This complexity often makes it difficult for average users to compose relational database queries.

Accordingly, query applications have been developed to simplify the process of composing a database query. For example, a data abstraction model may be used to provide a query application for users to compose a data query. Generally, a data abstraction model provides a query building interface focused on the substantive content of a particular database, independent from the particular manner of data representation (e.g., a relational schema) used by the database. Thus, the data abstraction model exposes data to users in an intuitive manner, and users may compose and submit queries without an understanding of the underlying storage mechanism. Using such applications, a user may compose a desired query and submit it to the DBMS (database management system) for processing. In response, the DBMS processes the query and returns a set of query results. Typically, the query result includes a table populated with rows that satisfy conditions specified by the query.

By providing query elements decoupled from the underlying physical database representation, users may more easily compose database queries. At the same time, however, users may desire to understand the complexity of a query element before including it in query element in a database query. This is particularly the case where new query elements may be added to the query application over time, and where new query elements may have unexpected performance characteristics.

Another situation where users may desire feedback regarding expected execution characteristics is when deciding whether to invoke features or functions of a software application. Software is often developed a modular fashion using programming modules such as classes, objects, shared libraries, etc. One of the advantages of using modular programming techniques is that the programming modules can be re-used in multiple software applications. This reusability decreases the time required to develop new software applications and also increases the stability of new software applications.

During the development of a software application, the programming modules making up the software must be tested and re-tested for functionality and stability. Generally, functionality refers to whether a software module operates correctly i.e., the functions of the module provide the intended results. Stability refers to the tendency or likelihood of a module to “crash” i.e., the likelihood of the module to stop performing its expected function or to stop responding to other parts of the system. To test software, developers often use certain tools like performance profilers, call graphs and coverage test tools.

Performance profiles may be used to analyze the software code and calculate how much time was spent executing each programming module. Call graph tools collect information about the many different execution flows in a program and how those flows relate to each other. From this information, it is possible to determine how long different composite execution flows may require to be executed. This can assist a software developer in determining which, if any, programming objects are malfunctioning or may need optimization. Code coverage test tools may assist a developer by monitoring which portions of program code have been executed. These tools can point out programming modules that are not being executed or that have not been adequately tested, as well as point out the performance of the programming modules that exist for a large software application.

When updates or new programs composed from existing code modules and new code modules are created, however, users are not typically provided any feedback as to the functionality or stability of the updates or new programs. Some of the updates or programs may function well, others may not.

In either case, it would be useful to provide users with advance feedback information regarding the expected performance or stability of a given query element or software module. Generally, however, it is not until a query element is included in a query, or a software function is invoked, that the user learns about the performance characteristics of these entities (i.e., by direct observation of actual performance). When the performance turns out to be poor or deviates from expectations, users often become frustrated. Furthermore, while the tools described above may be available to developers and testers, the tools are not generally available to users querying a database or executing a software code module included as part of a software application.

Accordingly, there is a need for techniques that present users with feedback regarding the expected performance or quality characteristics of software applications. For example, there is a need for need techniques that present users with feedback regarding the expected performance characteristics of query elements that may be included in a database query. Similarly, there is a need for providing the expected performance characteristics of functions features of a software application.

### SUMMARY OF THE INVENTION

Embodiments of the invention may be used to provide for the display of GUI component feedback for functionality tasks that are qualified by execution characteristics of software code modules and database query fields. Embodiments of the invention allow a user to obtain information regarding the possible effects of invoking a particular code module or adding a particular database field to a database query in advance.

One embodiment of the invention provides a computer-implemented method for presenting an expected execution characteristic for a user-selectable component of a software application. The method generally includes, selecting a set of user-selctable components provided by the software application, wherein the set of user-selectable components are presented to the user of the software application on a graphical display, and for each of the user-selectable components, analyzing the user-selectable component to determine the expected execution characteristic of the user-selectable component, the expected execution characteristic being a characterization of an impact that the user-selectable component may have on operation of the software application during execution of the user-selectable component. Once the expected execution characteristic is determined, the method generally includes, presenting, on the graphical display, an indication of the expected execution characteristics of each of the set of user-selectable components.

Another embodiment of the invention includes a computer-readable medium containing a program which, when executed, performs an operation for presenting an expected execution characteristic for a user-selectable component of a software application. The operation generally includes, selecting a set of user-selectable components provided by the software application, wherein the set of user-selectable components are presented to the user of the software application on a graphical display, and for each of the user-selectable components, analyzing the user-selectable component to determine the expected execution characteristic of the user-selectable component, the expected execution characteristic being a characterization of an impact that the user-selectable component may have on operation of the software application during execution of the user-selectable component. The operation generally further includes, presenting, on the graphical display, an indication of the expected execution characteristics of each of the set of user-selectable components.

Still another embodiment includes a computing device that generally includes a processor and a memory configured to store an application that includes instructions which, when executed by the processor, cause the processor to perform operations for presenting an expected execution characteristic for a user-selectable component of a software application. The operations generally include, selecting a set of user-selectable components provided by the software application, wherein the set of user-selectable components are presented to the user of the software application on a graphical display, and for each of the user-selectable components, analyzing the user-selectable component to determine the expected execution characteristic of the user-selectable component, the expected execution characteristic being a characterization of an impact that the user-selectable component may have on operation of the software application during execution of the user-selectable component. The operation generally further includes, presenting, on the graphical display, an indication of the expected execution characteristics of each of the set of user-selectable components.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

Note, however, that the appended drawings illustrate only typical embodiments of this invention and are therefore not to be considered limiting of its scope, for the invention may admit to other equally effective embodiments.

FIG. 1 is a block diagram illustrating a general purpose computer system used in accordance with embodiments of the invention.

FIG. 2A is a relational view of a software application environment configured to store execution characteristics of code modules, according to one embodiment of the invention.

FIG. 2B is a relational view of a database environment configured to store execution characteristics of database fields, according to one embodiment of the invention.

FIG. 3 is a flow chart illustrating a method for presenting an indication of the expected performance characteristics of a program function associated with a graphical user interface component, according to one embodiment of the invention.

FIG. 4 is a flow chart illustrating a method for presenting an indication of the expected performance characteristics of a database query element, according to one embodiment of the invention.

FIG. 5 illustrates an exemplary graphical user interface display that includes component feedback, according to one embodiment of the invention.

FIG. 6 illustrates an exemplary graphical user interface display of a database query building tool, according to one embodiment of the invention.

FIG. 7 is a relational view of software components configured according to one embodiment of the invention.

### DETAILED DESCRIPTION OF THE PREFERRED EMBODIMENTS

The present invention is generally directed to a system, method, and article of manufacture for presenting users with an indication of the expected execution or performance characteristics of a software application. In one embodiment, the software application may be part of a query tool used to compose a database query from a collection of query elements (also referred to herein as query fields). In this context, the expected performance may be the expected time of execution that will result from adding a particular query element to a database query. In another embodiment, the software application may provide a set of features or functions invoked using a GUI element such as a menu. In this context, the expected performance may be the expected reliability or efficiency of the functions displayed in a menu.

One embodiment is directed to using graphical display elements (e.g., icons, graphs, text) to display various performance, complexity, functional or quality characteristics associated with query elements or features of a software application. As used herein, the collection of characteristics is referred to as “execution characteristics” or “expected performance” regarding a database query element or software module. Generally, embodiments are used to provide an indication of expected performance, before a user composes a query that includes a given query element or invokes a given function or feature of an application program.

In one embodiment, an execution characteristic analysis component processes information about a given database query field or software module to calculate its expected execution characteristics. Once calculated, a GUI display may be configured to provide an indication of the expected performance characteristics. Displaying such information provides the user with feedback, in advance, as to the possible effects of adding a database query field to a query or executing a given function of an application program. Accordingly, the executed execution characteristics allow users to decide more intelligently whether to use a given query field in a query or whether to invoke a particular function or feature of a software application.

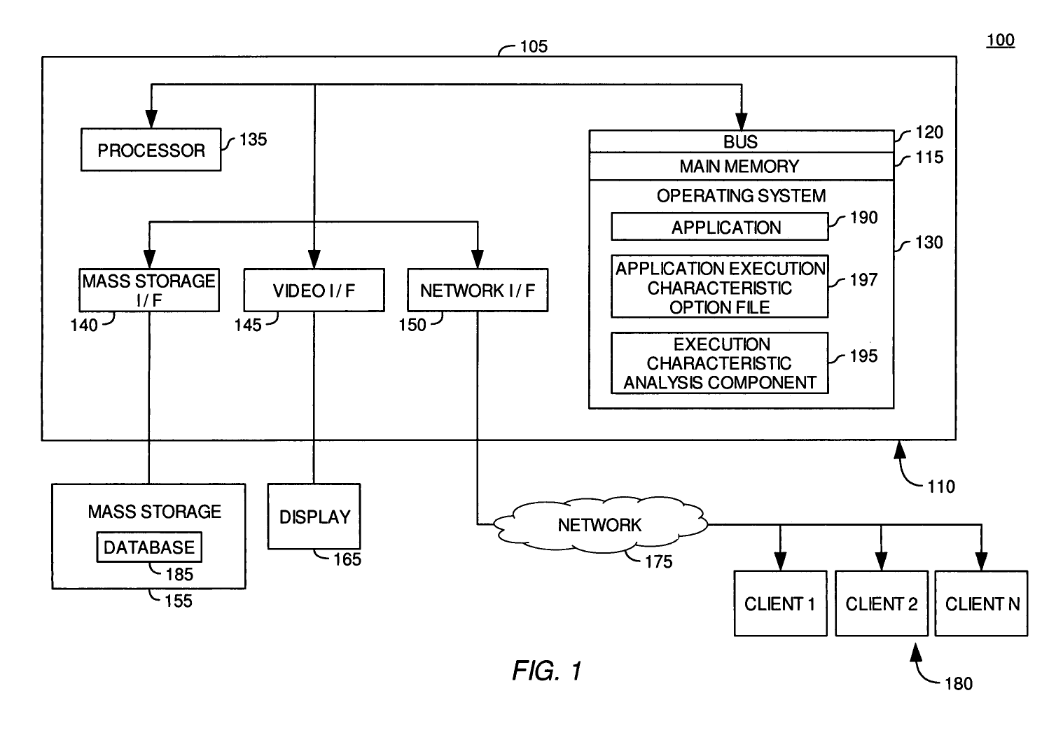

One embodiment of the invention is implemented as a program product for use with a computer system such as, for example, computer system 110 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information to/from the Intemet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### Physical View of the Environment

Referring now to FIG. 1, a distributed computing environment 100 is shown. In general, the environment 100 includes a computer system 105 and a network 175. The computer system 105 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. In one embodiment, the computer system 26 is an eServer iSeries 400 available from International Business Machines of Armonk, N.Y.

Illustratively, the computer system 105 comprises a networked system. However, the computer system 105 may also comprise a standalone device. In any case, it is understood that FIG. 1 is merely one configuration for a computer system. Embodiments of the invention can be adapted to any comparable configuration, regardless of whether the computer system 100 is a complicated multi-user apparatus, a single-user workstation, or a network appliance that does not have non-volatile storage of its own.

Embodiments of the present invention may also be practiced in distributed computing environments in which tasks are performed by remote processing devices linked through a communications network. In a distributed computing environment, program modules may be located in both local and remote memory storage devices. In this regard, the computer system 105 and/or one or more of the networked devices 175 may be thin clients which perform little or no processing.

The computer system 105 could include a number of operators and peripheral systems as shown, for example, by a mass storage interface 140 operably connected to a direct access storage device 155 containing a database 185, by a video interface 145 operably connected to a display 165, and by a network interface 175 operably connected to the plurality of networked devices 170 and 180 via a network 175 (e.g., WAN or LAN). The display 165 may be any video output device for outputting viewable information.

Computer system 105 is shown to include at least one processor 135, which obtains instructions and data via a bus 120 from a main memory 115. The processor 135 could be any processor adapted to support the methods of the invention.

The main memory 115 is any memory sufficiently large to hold the necessary programs and data structures. Main memory 115 could be one or a combination of memory devices, including Random Access Memory, nonvolatile or backup memory, (e.g., programmable or Flash memories, read-only memories, etc.). In addition, memory 115 may be considered to include memory physically located elsewhere in a computer system 105, for example, any storage capacity used as virtual memory or stored on a mass storage device (e.g., direct access storage device 155) or on another computer coupled to the computer system 105 via bus 120.

The memory 115 is shown configured with an operating system 130. The operating system 130 is the software used for managing the operation of the computer system 110. Examples of the operating system 130 include IBM OS/1550®, UNIX, Microsoft Windows®, a distribution of the Linux® operating system, and the like.

As shown, the memory 115 further includes a set of application programs. The applications 190, as well as the execution characteristic analysis component 195 are software products comprising a plurality of instructions that are resident at various times in various memory and storage devices in the computer system 110. When read and executed by one or more processors 135 in the computer system 110, the applications 190 and execution characteristic analysis component 195 cause the computer system 110 to perform the steps necessary to execute steps or elements embodying the various aspects of the invention. For example, in a query application context, the execution characteristics analyzed by the analysis component 195 may include complexity, performance, and perceived cost of including a particular query element in a database query. In other contexts, the execution characteristics analyzed by the analysis component 195 may include the expected quality, functionality, and stability associated with invoking a software function or feature provided by a software application.

### Relation View of Environment

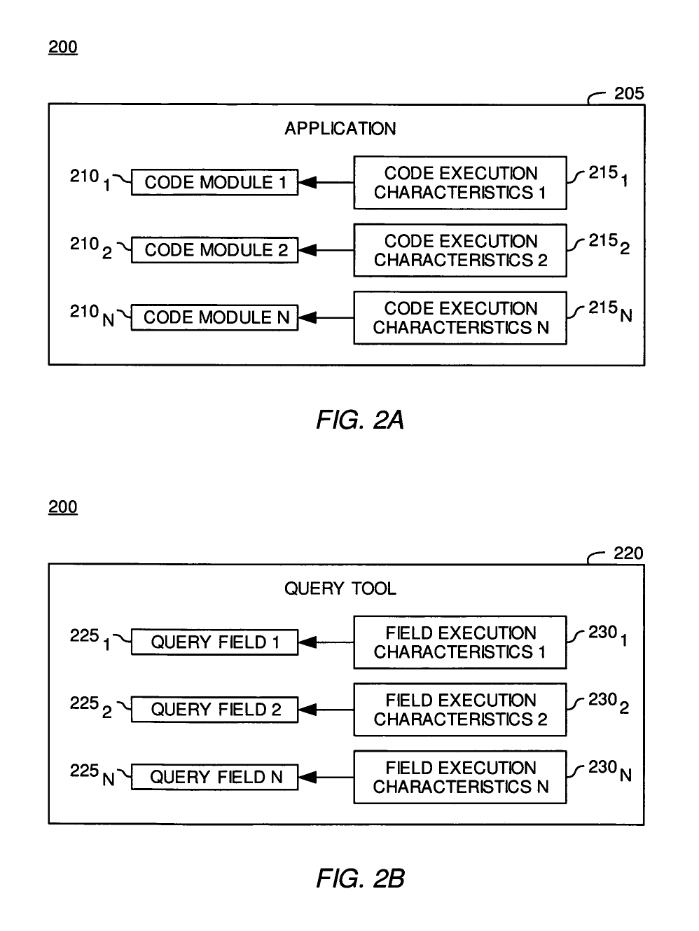

FIGS. 2A, 4, and 5 illustrate an embodiment of the invention in the context of a software application configured to present users with an indication of the expected performance characteristics of a program function associated with a graphical user interface component. FIGS. 2B, 3, and 6, illustrate an embodiment of the invention in the context of a database query tool presenting an indication of the expected performance characteristics of a database query element.

The execution characteristics may be used to provide users with an indication of expected application performance. For example, the execution characteristics associated with older (or more tested) modules or database query elements may be more stable, accurate, efficient, then when compared to the characteristics of newer (or less tested) modules or database query elements. In addition, the execution characteristics of specific software modules or database query elements may be determined from an analysis of the object in question. Thus, as new elements or modules are added to a software application, or as existing elements or modules are modified, the expected characteristics of these objects may be determined independently from one another.

### Expected Performance Characteristics—Gui Menu Item Example

FIG. 2A shows a relational view of a software application environment 200, according to one embodiment of the invention. As shown, the software application 205 contains a plurality of code modules 210₁, 210₂, 210_{N} (three shown by way of example, collectively referred to as code module 210). Each of the code modules 210 may be associated with a set of code execution characteristics 215₁, 215₂, 215_{N} (three shown by way of example, collectively referred to as code execution characteristics 215). In one embodiment, the code modules 210 each implement some function or feature provided by the software application 205.

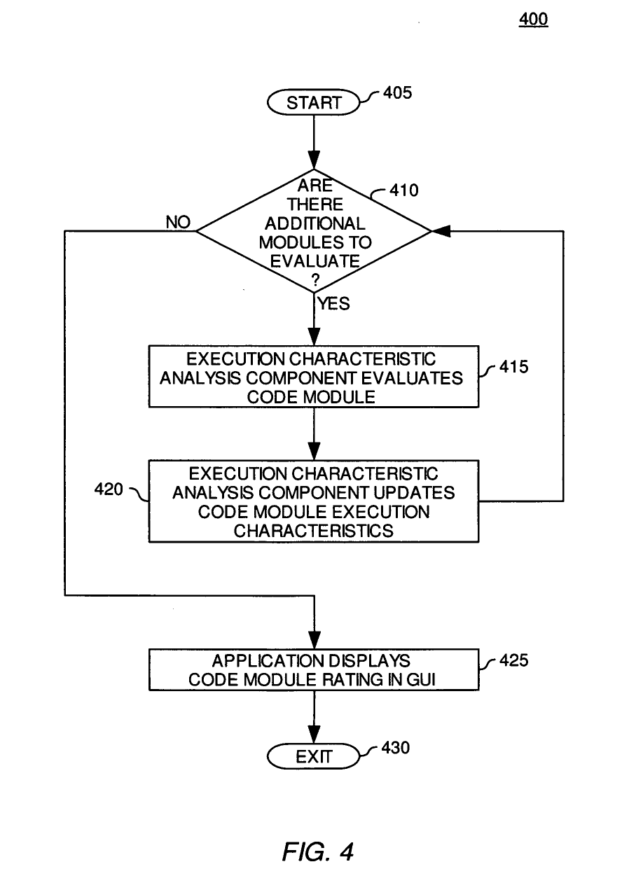

Embodiments of the invention may be used to provide feedback of expected execution characteristics 215 for each of the code modules 210. For example, the code modules 210 may correspond to functions users may invoke by selecting a menu item on graphical user interface display. Code module 210₁ may represent a function that is well-tested in the software application 205 (e.g., a printing function that has been available in application 205 for some time), whereas code module 210₂ may represent a recently developed function (e.g., a function implemented for a new release or update to software application 205). Thus, the execution characteristics 215 may be different for different features of the software application 205. And the expected performance characteristics presented to a user may reflect the expected performance differences between modules 210₁, and 210₂. A method for associating an expected performance characteristic 215 with the code modules 210 is described below in reference to FIG. 4.

FIG. 4 is a flow chart illustrating a method 400 for generating the code execution characteristics 215 for a code module 210, according to one embodiment of the invention. The method begins at step 405 where the analysis component 195 may identify a set of code modules to evaluate.

Once identified, the expected performance or execution characteristics of each code module may be evaluated using a loop that includes steps 410-420. At step 410, it is determined whether there are additional modules to evaluate. If so, then processing continues to step 415, where the analysis component 195 analyzes the code module under consideration. Otherwise, processing continues to step 425, described below. At step 415, the analysis component 195 analyzes the module under consideration. In one embodiment, the quality of a given software code module, as well as the how often the code module has been tested are used to calculate the execution characteristics of the code module. Typically, the more often a given code module has been used in an application (or applications), the higher the perceived quality of the code module. In one embodiment, applications such as coverage tools and call graph tools may be used to generate the data needed to evaluate the execution characteristics of the code module.

At step 420, the analysis component 195 updates the execution characteristic values for the code module under consideration. Processing returns to step 410 where it is determined whether additional code modules are left to be evaluated. Once all of the code modules have been evaluated, at step 425, an application (e.g., application 205) displays the execution characteristic values for the code module. Thus, before a user selects to invoke various functions or features of an application program, a display representing the expected performance characteristics of various functions may be presented to the user. The method 400 concludes at step 430.

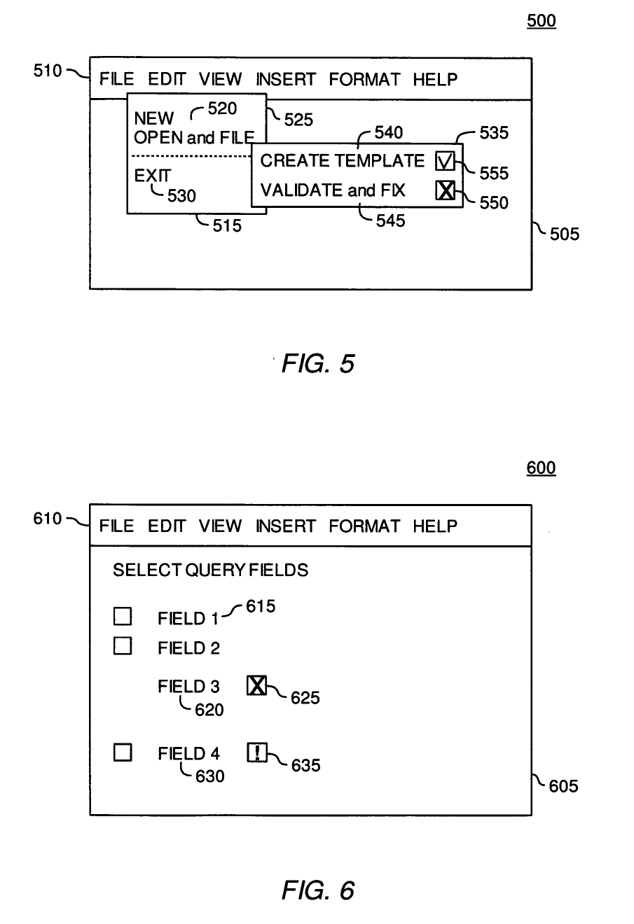

For example, FIG. 5 shows an embodiment of a user interface screen 500 of a GUI application 505. User interface 500 displays an example of an application menu with execution characteristics shown for individual menu selections. As shown, GUI application 505 includes a menu bar 510 with a plurality of functions or features of the software application that may be invoked using the menu bar 510. Illustratively, a user has chosen the FILE menu 515, which contains the menu choices of “NEW” 520, “OPEN and FILE”525, and EXIT 530. The user has then chosen the “OPEN and FILE” menu item 535, which contains the sub-menu choices of “CREATE TEMPLATE”540 and “VALIDATE and FIX” 545. Icons 550 and 555 display the Expected performance characteristics for menu items 540 and 540, respectively. As shown, the “CREATE TEMPLATE” menu item is shown adjacent to a “check” icon 550, which may indicate a favorable expected execution characteristic. For example, the menu function 540 may be associated with a highly tested code module, with well known performance characteristics. Conversely, menu item 545 is shown with an “X” icon, which may indicate an unfavorable expected execution characteristic. The “VALIDATE and FIX” 545 menu function may be relatively new, or may be associated with code indicated as not yet covered by a code coverage tool or call graph analysis.

Although illustrated in FIG. 5 using a graphical icon to provide an indication of expected execution performance, a variety of other graphical display effects may be used. For example, effects such as highlighting a menu item, using a red/yellow/green indicator, using an exclamation mark or red circle with a slash through. Each of these effects may be used to provide user feedback and contribute to building the correct expectations into the user experience.

In another embodiment, the software application 205 may perform additional actions beyond just presenting a graphical effect to indicate the expected performance characteristics of a program function. For example, if a function is determined to have a poor expected performance characteristic, the menu item may be disabled in conjunction with displaying the icons 550 and 555. Further, such actions may occur dynamically as users interact with the application. In such a case, the evaluation of the code modules that occurs as part of the method 400 illustrated in FIG. 4 may include criteria used to determine whether to enable or disable the menu item. For example, at certain performance or complexity scores, the icon is updated and disabled during normal business hours, but enabled other times. As another example, criteria may depend on the user interacting with the application 205. In such a scenario, for example, for a group of application developers working on the application, the indication of expected performance (e.g., icons 550 and 555) are graphically updated, but the menu function need not be disabled. At the same time, for users in other roles, such as a data entry team, a poor expected performance characteristic may cause the interface 500 to disable the menu function in conjunction with the display of icons 550 and 555.

### Expected Performance Characteristics—Database Query Tool Example

FIG. 2B shows a relational view of a query tool environment 200 that includes a plurality of user selectable query elements, configured according to one embodiment of the invention. As shown, the query tool 220 includes a plurality of query fields 225₁, 225₂, 225_{N} (three shown by way of example, collectively referred to as query field 225). Each of the query fields 225 is associated with a set of field execution characteristics 230₁, 230₂, 230_{N} (three shown by way of example, collectively referred to as field execution characteristics 230). Each query field 225 may provide an element that may be used to compose a database query.

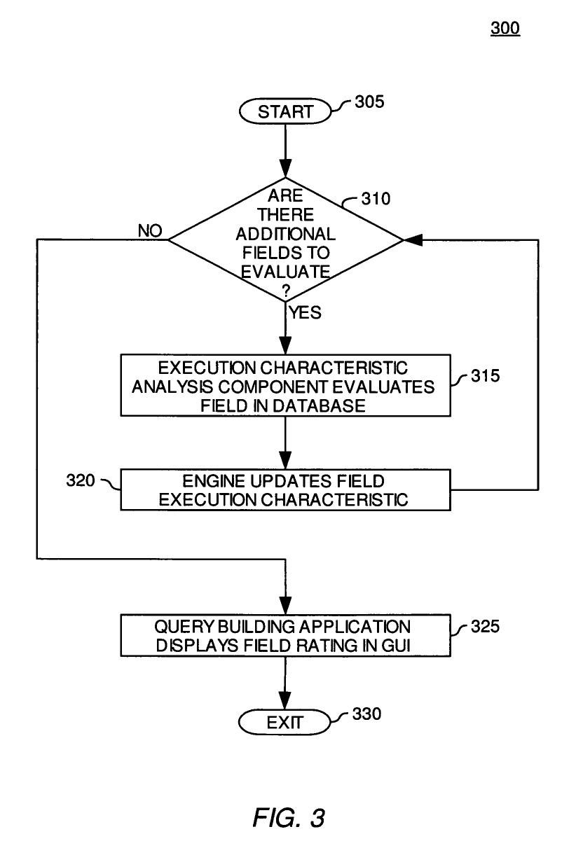

Embodiments of the invention may be used to provide users with feedback regarding the expected execution characteristics 230 of individual query fields 225, before a user selects a field 225 to include in a database query. The query fields 225 may correspond to query elements in an abstract query building application. For example, the query field 225₁ may represent an abstract query field having a very simple or direct relationship to the underlying database schema accessed by the query field 225 (e.g., the primary key of a table containing a small amount data). At the same time, query field 225₂ may represent an abstract query field which has a very complex relationship with the underlying database schema accessed by the field (e.g., a computed field requiring access to several relational database tables containing a large amount of data, or multiple table joining operations). Thus, execution characteristics 230 may be different for different query fields 225. A method for associating execution characteristics 230 with individual database query fields 225 is described below in reference to FIG. 3.

FIG. 3 is a flow chart illustrating a method 300 for generating the field execution characteristics 230 for a database query field 225, according to one embodiment of the invention. The method begins at step 305 where the analysis component 195 may identify a set of query fields to evaluate. The expected performance or execution characteristics of each field may be evaluated using a loop that includes steps 310-320.

At step 310, it is determined whether there are additional fields to evaluate. If so, processing continues to step 315 where the analysis component 195 analyzes the query field under consideration. In one embodiment, the analysis component 195 may be configured to evaluate the complexity of relationships between the field under consideration and other fields included in a query being composed by a user. Alternatively, the analysis component 195 may be configured to evaluate the field definition to determine an expected impact of including the field on query execution time. For example, consider the following definition an abstract query field called “Birth Date” (only the simplest relevant portion of the field definition is shown):

TABLE I
- Example Simple Query Element -

<Composition >

DATE(<FieldRef name=“data://PERSON/BIRTH_TIME”/>)

</Composition>

In this example, the “Birth Date” query element is represented using extensible markup Language (XML). Those skilled in the art will recognize that XML is a well known markup language used to facilitate the sharing of structured text and information, other markup languages, however, may be used. As shown, the “Birth Date” query element is mapped to an underlying physical database location, specifically a column named “BIRTH₁₃ TIME” in a “PERSON” table. Because it simply retrieves data from a column and performs a simple mathematical calculation to provide a query result, this field may be inexpensive to add to a query. A more complex example of a query field definition is provided in for an “Age at Pharmacological Administration” field:

TABLE II
- Example Complex Query Element -

<Composition >

CASE WHEN

<FieldRef name=“data://V_PHARMA_DT_GTS_TS/TIME_STAMP”/> IS NULL

THEN YEAR(<FieldRef name=“data://V_PHARMA_DT_IVL_TS/LOW”/> -
<FieldRef name=“data://PERSON/BIRTH_TIME”/>)
ELSE

YEAR(<FieldRef name=“data://V_PHARMA_DT_GTS_TS/TIME_STAMP”/> -

<FieldRef name=“data:// PERSON/BIRTH_TIME”/>)
END

</Composition>
<Where >

<Condition field=“data://VT_PHARMAT_OBSERVATION/OBS_CODE”
operator=“EQ” >
<Value defaultSelection=“No” val=“#p2”/>
</Condition>

</Where>

By analyzing this field, the analysis component 195 may determine that adding the “Age at Pharmacological Administration” to a query element involves significant additional processing to retrieve query results. At a minimum, processing this field requires evaluating the CASE statement to select which branch to follow, retrieving data from tables specified in the selected branch, and then joining this information with data from another table. However, in the database query application 220, both the “Birth Date” and “Age at Pharmacological Administration” fields may simply be displayed as a list of fields that may be included in a database query, without providing any indication of underlying complexity. In one embodiment, users may be presented with an indication of the different expected performance characteristics for these fields by displaying an icon representing the relative complexity adjacent to each field in the list.

Returning to the method illustrated in FIG. 3, at step 320, the execution characteristic analysis component 195 updates the execution characteristic values for the query field. For example, using the fields illustrated in Tables I and II above, the values for the “birth date” query field are likely reflect the much simpler processing demands than the values for the “Age at Pharmacological administration” field. Processing then returns to step 310 where it is determined if additional fields are left to be evaluated. Once all of the fields to have been evaluated, at step 325, a query tool 220 may be configured to display the expected execution characteristic values for the query fields. Thus, when users compose a database query, a display representing the expected performance characteristics of various query fields may be presented to a user.

Generally, a query application (e.g., query tool 220) may be configured to allow users to select fields to include in a database query. In one embodiment, the expected execution characteristics presented for a set of query fields may remain static as users add various fields to a query. In an alternative embodiment, however, the analysis component 195 may provide the display of performance characteristics for both individual query fields, as well as for the query itself, based on the particular selection of multiple query fields included in a database query. Such a performance characteristic may be the additive sum of the individual performance characteristics, but may also be based on an analysis of particular query fields as well.

FIG. 6 shows one embodiment of a user interface screen 600 of a GUI query builder tool 605. User interface 600 may be provided by query builder application 205. As shown, the interface 600 includes a number of query fields, a menu bar 610. In one embodiment, a user may compose a database query by selecting which available database query fields to include in the query. The GUI query builder tool 605 may be configured to present a user with the list of available query fields. In the example, the two fields “FIELD 1” and “FIELD 2” 615 are both available to add to a given query. The field “FIELD 3” 620 is shown with an “X” expected performance characteristic 625. This field is also shown without a checkbox to indicate that this field is unavailable for query building. One example that may result in a query field being unavailable to include in a query is when execution characteristics for the field are below some administrator-configured threshold value. The query field “FIELD 4” has an “!” status icon 635 to represent that while the field is available for query building, some aspect of the execution characteristics may indicate potential problems (such as extended query execution time or questionable returned data values) associated with using the field.

In both FIG. 5 and FIG. 6 above, it is important to note that the representative icons may be applied to the code module and query field in the respective applications before a user executes the code module or adds the query field to a query. This allows the user to make an informed decision as to whether to invoke the code module or include the query field to a query. As described, a software application 205 or query tool 220 may be configured to prevent the execution of code modules or addition of query fields that have execution characteristics above some configured.

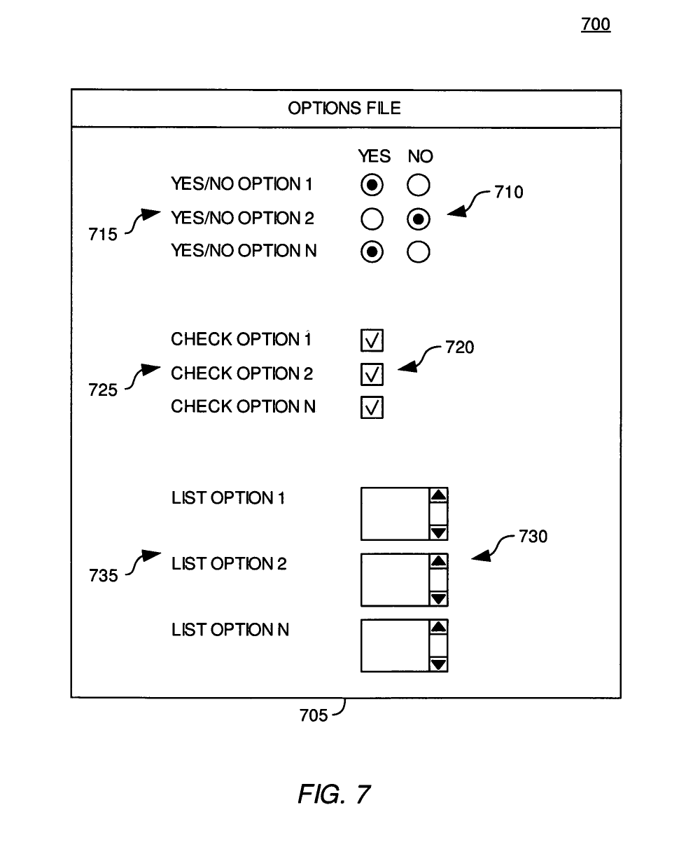

FIG. 7 illustrates an embodiment of an option configuration screen 700 for the execution characteristics analysis component 195. In one embodiment, an option screen 705 is provided to an administrator user (administrator) of a software application 205 or query tool 220. Selections made via the option screen 705 are saved in an application execution characteristic option file 197, from which they can be subsequently retrieved and applied to configure the operation of the software application 205 or query tool 220. Thus, the administrator may use the option screen 705 to configure a plurality of different execution characteristic options.

FIG. 7 shows a plurality of Yes/No option questions 715₁, 715₂, 715_{N} (three shown by way of example; collectively referred to as option question 715) and a plurality of Yes/No option buttons 710₁, 710₂, 710_{N} (three shown by way of example; collectively referred to as option buttons 710). Generally, option buttons 710 allow the user to select an answer to an option question from a set of choices. As shown, the option question includes yes/no option questions, but option questions with more than two possible answer choices are also contemplated. Examples of an option question 715 include “Display Execution Characteristic Status Icon?”, “Grey Out Disabled Fields?”, “Allow User Thresholds?” etc. The user activates a corresponding option by selecting the desired radio buttons.

FIG. 7 also shows a plurality of check box questions 725₁, 725₂, 725_{N} (three shown by way of example; collectively referred to as check box question(s) 725) and a plurality of respective check boxes 720₁, 720₂, 720_{N} (three shown by way of example; collectively referred to as check boxes 720). Generally, the check box questions 725 allow the user to select to enable or disable aspects of how an expected execution characteristic is calculated, or how the software application may respond to an expected performance characteristic. Examples of a check box question 725 include “Enable High-Risk Code Modules”, “Enable Time-Dependent Field Access”, etc.

FIG. 7 also shows a plurality of list box questions 735₁, 735₂, 735_{N} (three shown by way of example; collectively referred to as list box question 735) and a plurality of list boxes 730₁, 730₂, 730_{N} (three shown by way of example; collectively referred to as list boxes 730). Generally, the list box questions 735 allow the user to select an answer for an option question from a list of accepted values. The option question may be related to the expected execution characteristics for a given query element or code module. Examples of a list box question 735 might be “Choose Color for High Risk Code Modules”, “Set Disable Threshold Value”, etc. Collectively, the option questions 715, check box questions 725, list box questions 735 allow an administrator to determine how the expected execution characteristic of a function or feature provided by a software application is calculated, displayed, or otherwise impacts the functionality of the software application. (e.g., application 205, or database query tool 220).

### Conclusion

By providing for the display of GUI component feedback for functionality tasks that are qualified by execution characteristics of software code modules and database query fields, embodiments of the present invention allow a user to obtain information regarding the possible effects of invoking a particular code module or adding a particular database field to a database query in advance. As a result, the user may be allowed to better optimize interactions with the software application or database. At the same time, providing GUI component feedback contributes to building the correct expectations into the user experience.

While the foregoing is directed to embodiments of the present invention, other and further embodiments of the invention may be devised without departing from the basic scope thereof, and the scope thereof is determined by the claims that follow.

What is claimed is:

1. A computer-implemented method for presenting an expected execution characteristic for a user-selectable component of a software application, comprising:
selecting a set of user-selectable components provided by the software application, wherein the set of user-selectable components are presented to the user of the software application on a graphical display;
for each of the user-selectable components, analyzing the user-selectable component to determine the expected execution characteristic of the user-selectable component, the expected execution characteristic being a characterization of an impact that the user-selectable component may have on operation of the software application during execution of the user-selectable component; and
presenting, on the graphical display, an indication of the expected execution characteristics of each of the set of user-selectable components.

2. The method of claim 1, wherein the user-selectable component comprises a database query field that may be included in a database query composed using a database query tool.

3. The method of claim 2, wherein the expected execution characteristic comprises a measure of time required to execute the database query if the database query field is included in the query.

4. The method of claim 2, wherein the expected execution characteristic provides a measure of the complexity of the database query that will result from including the database query field in the database query.

5. The method of claim 1, wherein the selecting the user-selectable component causes the software application to invoke a code module that provides the functionality accessed using the user-selectable component.

6. The method of claim 5, wherein the expected execution characteristic provides a measure of the expected reliability or efficiency of the code module.

7. The method of claim 5, wherein a code coverage tool or call graph analysis tool is used to analyze the code module to determine the expected execution characteristic of the user-selectable component.

8. The method of claim 1, wherein set of user-selectable components are presented to the user as a menu display component of a graphical user interface.

9. The method of claim 1, further comprising, disabling a given user-selectable component from being selected by the user if the expected execution characteristic is determined to be below a specified threshold.

10. The method of claim 9, wherein the user-selectable component is disabled only during periods of peak activity of use of the software application or for specified users of the software application.

11. A computer-readable medium containing a program which, when executed, performs an operation for presenting an expected execution characteristic for a user-selectable component of a software application, comprising:
selecting a set of user-selectable components provided by the software application, wherein the set of user-selectable components are presented to the user of the software application on a graphical display;
for each of the user-selectable components, analyzing the user-selectable component to determine the expected execution characteristic of the user-selectable component, the expected execution characteristic being a characterization of an impact that the user-selectable component may have on operation of the software application during execution of the user-selectable component; and
presenting, on the graphical display, an indication of the expected execution characteristics of each of the set of user-selectable components.

12. The computer-readable medium of claim 11, wherein the user-selectable component comprises a database query field that may be included in a database query composed using a database query tool.

13. The computer-readable medium of claim 12, wherein the expected execution characteristic comprises a measure of time required to execute the database query if the database query field is included in the query.

14. The computer-readable medium of claim 12, wherein the expected execution characteristic provides a measure of the complexity of the database query that will result from including the database query field in the database query.

15. The computer-readable medium of claim 11, wherein the selecting the user-selectable component causes the software application to invoke a code module that provides the functionality accessed using the user-selectable component.

16. The computer-readable medium of claim 15, wherein the expected execution characteristic provides a measure of the expected reliability or efficiency of the code module.

17. The computer-readable medium of claim 15, wherein a code coverage tool or call graph analysis tool is used to analyze the code module to determine the expected execution characteristic of the user-selectable component.

18. The computer-readable medium of claim 11, wherein set of user-selectable components are presented to the user as a menu display component of a graphical user interface.

19. The computer-readable medium of claim 11, wherein the operation further comprises, disabling a given user-selectable component from being selected by the user if the expected execution characteristic is determined to be below a specified threshold.

20. The computer-readable medium of claim 19, wherein the user-selectable component is disabled only during periods of peak activity of use of the software application or for specified users of the software application.

21. A computing device comprising:
a processor; and
a memory configured to store an application that includes instructions which, when executed by the processor, cause the processor to perform operations for presenting an expected execution characteristic for a user-selectable component of a software application, comprising:
selecting a set of user-selectable components provided by the software application, wherein the set of user-selectable components are presented to the user of the software application on a graphical display;
for each of the user-selectable components, analyzing the user-selectable component to determine the expected execution characteristic of the user-selectable component, the expected execution characteristic being a characterization of an impact that the user-selectable component may have on operation of the software application during execution of the user-selectable component; and
presenting, on the graphical display, an indication of the expected execution characteristics of each of the set of user-selectable components.

22. The computing device of claim 21, wherein the user-selectable component comprises a database query field that may be included in a database query composed using a database query tool.

23. The computing device of claim 21, wherein the selecting the user-selectable component causes the software application to invoke a code module that provides the functionality accessed using the user-selectable component.
